(19) United States
(12) Patent Application Publication
(10) Pub. No.: US 2002/0141709 A1
(43) Pub. Date: Oct. 3, 2002

(54) Small-formed optical module

(76) Inventor: Ki Chul Shin, Gunpo-city (KR)

Correspondence Address: ROBERTS ABOKHAIR & MARDULA, SUITE 1000, 11800 SUNRISE VALLEY DRIVE, RESTON, VA, 20191, US

(21) Appl. No.: 10/107,862

(22) Filed: Mar. 27, 2002

(30) Foreign Application Priority Data
Mar. 28, 2001 (KR) 2001-16115
Mar. 28, 2001 (KR) 2001-16117
Mar. 22, 2002 (KR) 2002-15698

(51) Int. Cl. G02B 6/42

(52) U.S. Cl. 385/92; 385/93

(57) ABSTRACT

An optical module, in which one end of pins formed on the package is electrically connected to an inner active element and the other end of the pins is protruded from the package parallel to the bottom surface of the package, is provided. The package is easily mounted on a circuit board. And, an overall size of the package is reduced by properly adjusting the number of the pins, thereby integrating the optical transmitting module and the optical receiving module as one optical module.

### RELATIONSHIP TO PRIOR APPLICATIONS

This application claims the benefit under 35 U.S.C. §119 of Korean Patent Application No. 2001-16115, filed Mar. 28, 2001, Korean Patent Application No. 2001-16117, filed Mar. 28, 2001, and Korean Patent Application No. 2002-15698, filed Mar. 22, 2002.

### FIELD OF THE INVENTION

The present invention relates to a small-formed optical module, and more particularly to an optical module with plural outer pins laterally protruding from a package body, thereby being easily mounted on a circuit board,reducing an overall size of the package. Therefore, the optical module of the present invention is capable of integrating an optical transmitting module and an optical receiving module.

### BACKGROUND

As well known to those skilled in the art, in order to advance the information age, an optical module for transmitting a large quantity of data has been recently required. Such an optical module demands not only excellent self-characteristics but also reliability so as to maintain the characteristics for a long time. In order to promote the sad of this optical module to implement a FTTH (fiber to the home) system, the optical module should be offered at a moderate price. Particularly, as capacity of the optical transmission system has been increased, attempts to reduce the size of the optical module installed on the optical transmission system and to increase the number of the installable optical modules on the unit area of the optical transmission system are now under way.

An active element of the optical module serves to change electric signals into optical signals or optical signals into electric signals. Generally, methods of aligning the active element of the optical module (for example, such as a laser diode and a photo diode) and an optical fiber are divided into two, i.e., an active alignment method and a passive alignment method.

In the active alignment method, a location for maximally outputting an optical power is searched by operating a specific facility with fine resolution of less than μm unit, and then the active elements and the optical fibers are aligned on this optimum location. Therefore, the active alignment method requires many long hours, thereby hindering mass-production of the optical module. Further, the active alignment method requires additional equipment such as the aforementioned facility, thereby increasing the production cost and lowering a competitiveness of the optical module.

On the other hand, in the passive alignment method, the active elements and the optical fibers are exactly aligned without current supply. The maximum power output is obtained by exactly aligning the active element prior to a step of aligning the optical fiber.

The conventional optical modules are mostly manufactured by the active alignment method using the high-priced facility with fine resolution. Therefore, the production time of the optical module is lengthened, thereby increasing the production cost and reducing the productivity.

FIGS. 1a and 1b are a perspective view and a cross-sectional view of a conventional optical module.

As shown in FIGS. 1a and 1b, 8 pins of the conventional mini-DIL type package are perpendicularly formed on the module. In order to be mounted on a printed circuit board, the package is turned at the angle of 90 degrees and mounted on the printed circuit board. Herein, the circuit board itself is also turned at the angle of 90 degrees to the module, thereby complicating its production process.

Moreover, since 8 pins are perpendicularly attached to both sides of the package, it is difficult to parallel install two packages such as a transmission package and a reception package.

### SUMMARY OF THE INVENTION

Therefore, the present invention has been made in view of the above problems, and it is an object of the present invention to provide an optical module with plural outer pins laterally protruding from one surface of a package, thereby reducing the size of the package and easily mounting the optical module on a circuit board

In accordance with one aspect of the present invention, the above and other objects can be accomplished by the provision of an optical transmitting module comprising a substrate with active elements attached thereto, and a package comprising a light collecting means for transmitting the light generated from a luminous element to an optical fiber and pins for electrically connecting the package to an external device. Herein, one end of the pin is electrically connected to the active element and the other end of the pin is protruded from the package parallel to the bottom surface of the package.

Preferably, a protrusion with a designated shape may be formed on one of the bottom surface of the substrate and the bottom surface of a cavity of the package, and a depression to be matched with the protrusion may be formed on the other. Thus, the passive alignment between the package and the substrate is achieved by matching the protrusion with the depression.

Further, preferably, the light collecting means may comprise a guide pipe and a ferrule inserted into the guide pipe. The ferrule may be, if inserted, tightly coupled with the guide pipe by allowing an internal diameter of the guide pipe to be substantially as much as an external diameter of the ferrule.

In accordance with another aspect of the present invention, there is provided an optical receiving module comprising a substrate with a light receiving element attached thereto, and a package comprising a light collecting means for transmitting the light to the light receiving element and pins for electrically connecting the package to an external device. Herein, one end of the pin is electrically connected to the light receiving element and the other end of the pin is protruded from the package parallel to the bottom surface of the package.

Preferably, a protrusion with a designated shape may be formed on one of the bottom surface of the substrate and the bottom surface of a cavity of the package, and a depression to be matched with the protrusion may be formed on the other. Thus, the passive alignment between the package and the substrate is achieved by matching the protrusion with the depression.

Further, preferably, the light collecting means may comprise a guide pipe and a ferrule inserted into the guide pipe. The ferrule may be, if inserted tightly coupled with the guide pipe by allowing an internal diameter of the guide pipe to be substantially as much as an external diameter of the ferrule.

In accordance with yet another aspect of the present invention, there is provided an optical transceiver module formed by integrating the optical transmitting module and the optical receiving module.

### BRIEF DESCRIPTION OF THE DRAWINGS

The above and other objects, features and other advantages of the present invention will be more clearly understood from the following detailed description taken in conjunction with the accompanying drawings, in which.

FIGS. 1a and 1b are a perspective view and a cross-sectional view of a conventional optical module, respectively,

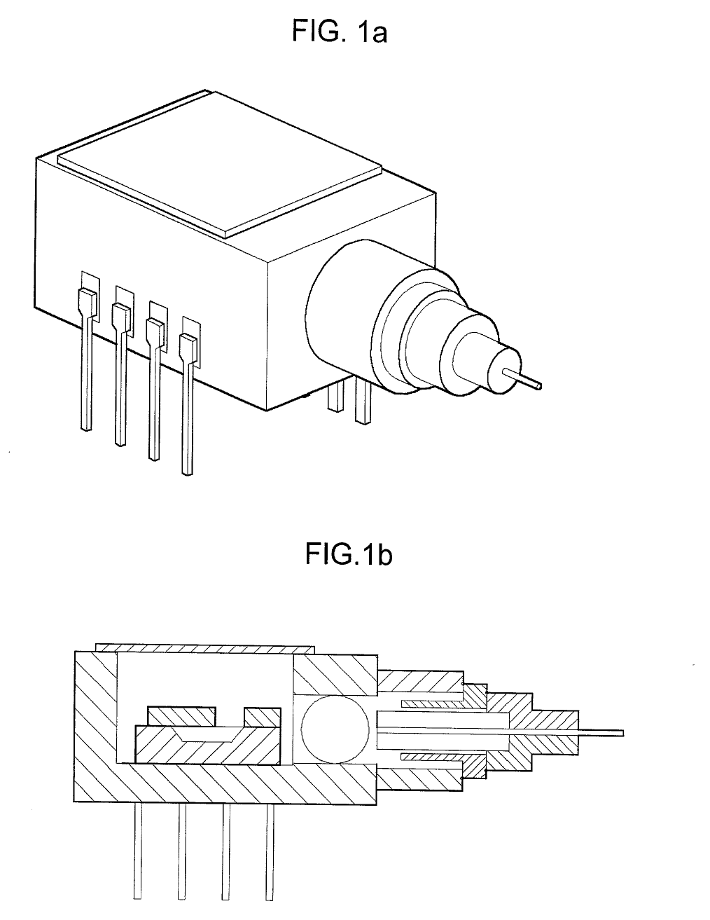

FIG. 2 is a cross-sectional view of an optical transmitting module in accordance with an embodiment of the present invention;

FIGS. 3a, 3b, and 3c are a top view, a perspective view, and a bottom view of transmitting substrate with active elements attached thereto of the optical transmitting module of FIG. 2, respectively;

FIG. 4 is an exploded perspective view of the optical transmitting module of FIG. 2;

FIG. 5 is a cross-sectional view of an optical receiving module in accordance with another embodiment of the present invention;

FIGS. 6a, 6b, and 6c are a top view, a perspective view, and a bottom view of a receiving substrate with a light receiving element attached thereto of the optical receiving module of FIG. 5, respectively; and

FIG. 7 is an exploded perspective view of the optical receiving module of FIG. 5; and

FIG. 8 is an exploded perspective view of an optical transceiver module in accordance with yet another embodiment of the present invention.

### DESCRIPTION OF THE PREFERRED EMBODIMENTS

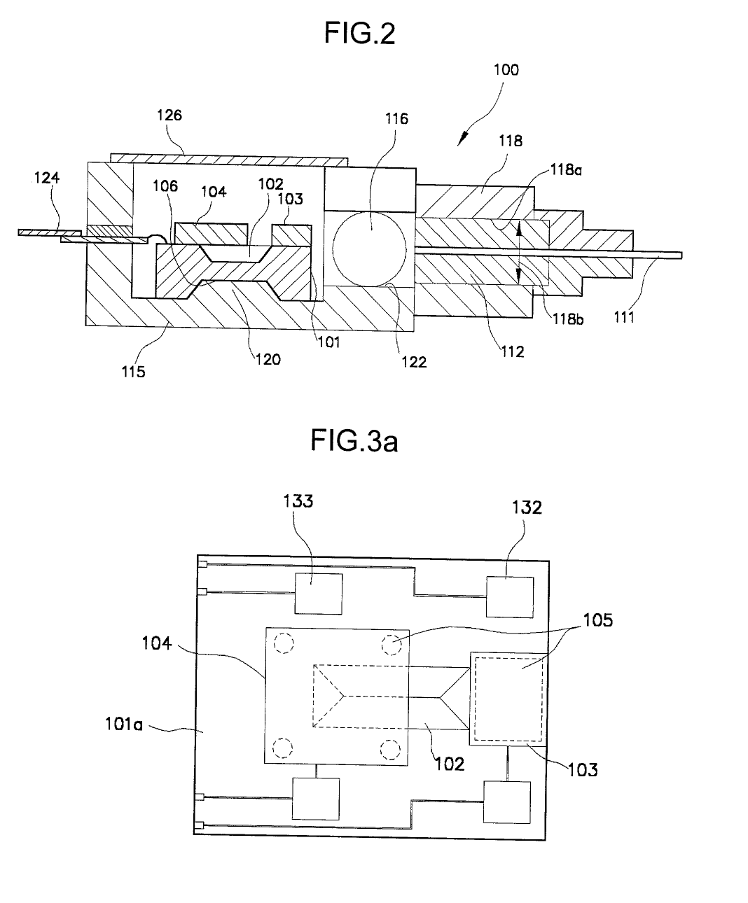

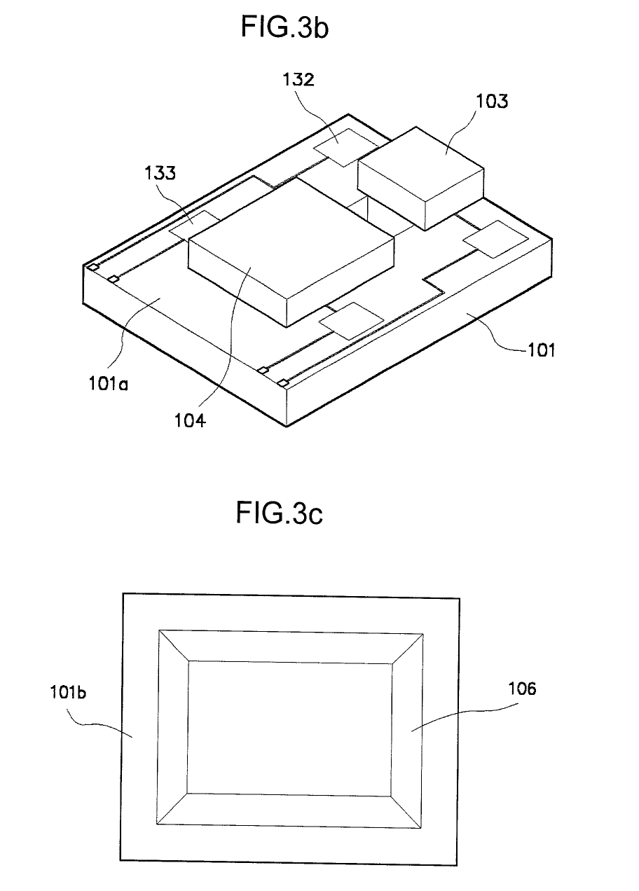

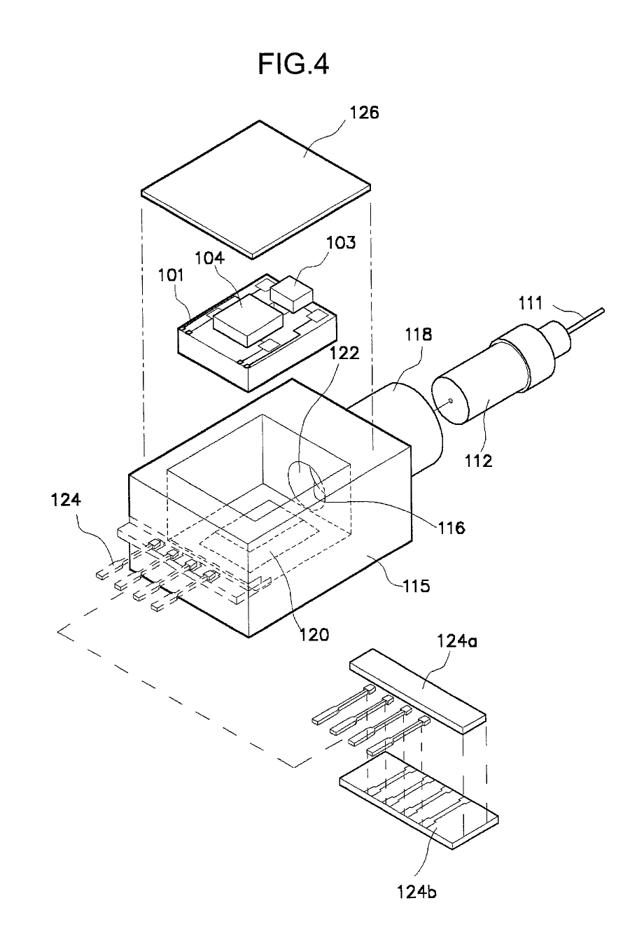

FIG. 2 is a cross-sectional view of an optical transmitting module in accordance with an embodiment of the present invention. FIGS. 3a, 3b, and 3c are a top view, a perspective view, and a bottom view of a transmitting substrate with active elements attached thereto of the optical transmitting module of FIG. 2, respectively. FIG. 4 is an exploded perspective view of the optical transmitting module of FIG. 2.

With reference to FIGS. 2 to 4, the optical transmitting module 100 in accordance with an embodiment of the present invention is described hereinafrer.

The optical transmission module 100 includes a light collecting means formed on the front surface, an integrated module package 115 with a pin structure in which plural protruding pins are parallel to the bottom surface of the package 115, a substrate 101 attached to the bottom surface of a cavity of the package 115 (i.e., the upper surface of a bottom wall of the cavity of said package), and a luminous element 103 and a light receiving element 104 attached to the upper surface of the substrate to 101. The light receiving element 104 acts as a sensor for controlling the optical power output of the luminous element 103.

The light collecting means includes a lens insertion hole 122 and at transmitting lens 116 formed on the front surface of the package 115, and transmitting guide pipe 118 connected to the lens insertion hole 122 and provided with a hollow 118a in which transmitting ferrule 112 is inserted.

The position of the light collecting means is not limited to the front surface of the package 115. If the light emitting surface of the luminous element 103 is vertical to the ground surface, the light collecting means is formed on the upper surface of the package 115. Therefore, the position of the light collecting means is changeable by the position of the light emitting surface of the luminous element 103.

The transmitting lens 116 usually employs a ball lens and is installed on a precalculated area within the lens insertion hole 122 so that the light from the luminous element 103 is concentrated on a core of an optical fiber 111 within the transmitting ferrule 112.

The transmitting guide pipe 118 includes the hollow 118a, in which the transmitting ferrule 112 provided with the optical fiber 111 is inserted The shape of the transmitting ferrule 112 is not limited. Preferably, the transmission ferrule 112 is cylindrical in shape. In this case, by allowing the internal diameter 118b of the hollow 118a to be substantially as much as the external diameter of the transmitting ferrule 112, even though the cylinder-shaped transmitting ferrule 112 is inserted in any direction into the hollow 118a, the light is concentrated exactly on the core of the optical fiber 111.

The package 115 is made of ceramic, metal including alloy, or its equivalents, but is not limited thereto. Preferably, a protrusion 120 with a designated shape for fixing the substrate 101 is formed on the bottom surface of the cavity of the package 115, and an opening for introducing the substrate 101 and a cover 126 are formed on the upper surface of the package 115. Herein, the position of the opening is not limited thereto, but is changeable by the position of the light collecting means.

The protrusion 120 formed on the bottom surface of the cavity of the package 115 serves to fix the substrate 101, the height of which is adjusted so that the luminous element 103 formed on the optimum position projects light on the transmission lens 116. The shape of the protrusion 120 is also not limited. Therefore, the shape of the protrusion 120 may include a V-groove or a MESA structure with an inclined sidewall at a designated angle.

A designated pin structure for electrically connecting the inner active elements including the luminous element 103 and the light receiving element 104 to an external circuit board (not show) is formed on one surface of the package. The pins 124 of this structure are usually a form of leads of the lead frame and are formed parallel to the bottom surface of the package 115.

As shown in FIG. 4, the pins 124 are attached to a lower insulating board 124b with pattern formed thereon by a brazing method. Then, an upper insulating board 124a is attached thereto.

Preferably, in order to reduce the overall size of the package, the number of the pins 124 is minimized. This embodiment of the present invention includes at least four pins, thereby reducing the size of the package. Further, the pins 124 are protruded from the package 115 parallel to the bottom surface of the package 115, thereby easily mounting the package 115 on the circuit board. By the aforementioned structure of the pins 124, the optical transmitting module and the optical receiving module can be integrated as one module.

Preferably, the substrate 101 is a semiconductor substrate, for example, a silicon substrate. The luminous element 103 is attached by a solder 105 to a front area of the upper surface of the substrate 101 of which height is adjusted so that the optimum light is projected on the transmitting lens 116. The monitoring light receiving element 104 for sensing the light irradiated from the back surface of the luminous element 103 is attached by the solder 105 to a rear area of the upper surface of the substrate 101. A reflection groove 102 with a designated shape is formed below the light receiving element 104. The reflection groove 102 reflects the light irradiated from the back surface of the luminous element 103 and projects the reflected light onto the surface of the light receiving element 104. Preferably, the reflection groove 102 includes a V-shaped groove with a designated width and depth, but is not limited thereto. The width and the depth of the reflection groove 102 are determined by the orientation of crystal of the substrate 101.

The luminous element 103 and the light receiving element 104 are not limited to each of the above-described positions. For example, the luminous element may be mounted on the monitoring light receiving element. With this configuration, a designated amount of the light generated from the luminous element is reflected and the reflected light is projected on the upper surface of the light receiving element.

In order to electrically connect the luminous element 103 and the light receiving element 104 to the pins 124, contact points 132, 133 and patterns are formed on a designated location of the substrate 101.

A laser diode is generally used as the luminous element 103. Preferably, the bottom surface of the laser diode has an uneven structure (including prominences and depressions) with the height and size, which are predetermined by the orientation by the crystallographic characteristic of single crystal. In this case, a corresponding uneven structure of the same predetermined height and size is formed on a designated area of the substrate 101. Thereby, the luminous element 103 is exactly received on the substrate 101 without an additional alignment method.

A photo diode is generally used as the monitoring light receiving element 104. The light receiving element 104 controls the light irradiated by the luminous element 103 by sensing the intensity of the light projected on the surface of the light receiving element 104. Herein, a control circuit of the light receiving element 104 may be formed on an external electronic circuit board (not shown). Since this control circuit is apparent to those skilled in the art its detailed description is omitted.

A depression 106 with a predetermined shape and size to be matched with the protrusion 120 formed on the bottom surface of the cavity of the package 115 is formed on the bottom surface 101b of the substrate 101. The depression 106 may be formed by any conventional etching method.

The passive alignment between the package 115 and the substrate 101 is simply achieved by matching the depression 106 of the substrate 101 with the protrusion 120 of the bottom surface of the package 115. That is, since the final position of the luminous element 103 is predetermined so that the optical axis is exactly located on the core of the optical fiber 111 within the ferrule 112, the passive alignment can be simply completed by only a subsequent step of inserting and fixing the transmitting ferrule 112 into the package 115.

The optical transmitting module of the present invention may be a multi-optical transmitting module provided with at least two parallel-connected optical transmitting modules.

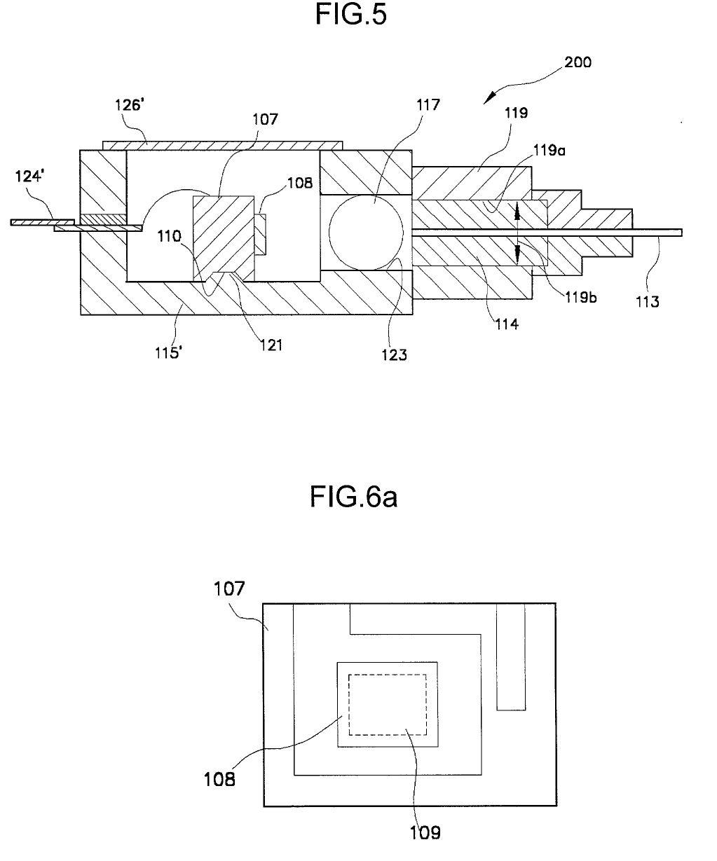

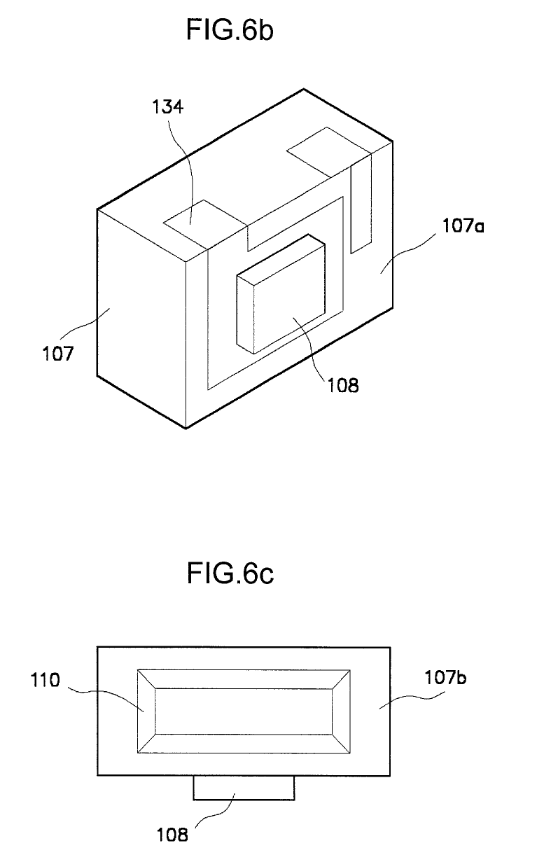

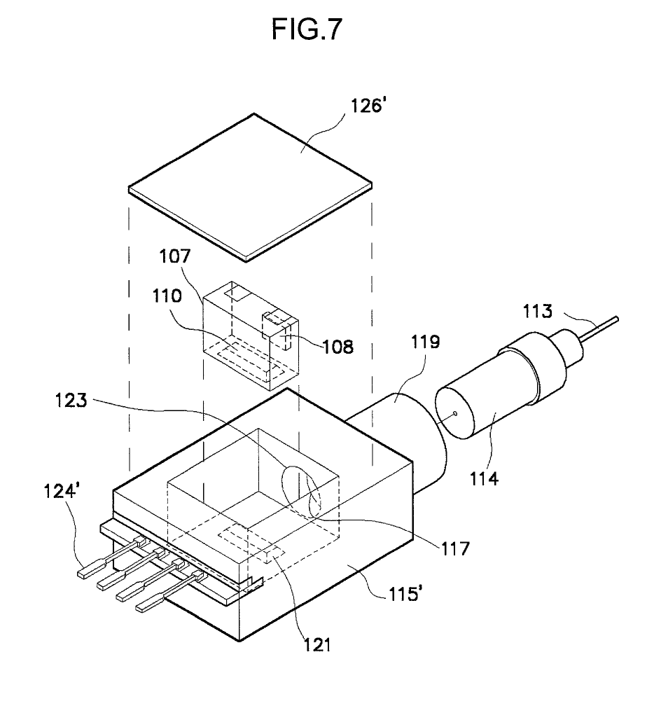

FIG. 5 is a cross-sectional view of an optical receiving module in accordance with another embodiment of the present invention. FIGS. 6a, 6b, and 6c are a top view, a perspective view, and a bottom view of a receiving substrate with a light receiving element attached thereto of the optical receiving module of FIG. 5, respectively. FIG. 7 is an exploded perspective view of the optical receiving module of FIG. 5.

With reference to FIGS. 5 to 7, the optical receiving module 200 in accordance with another embodiment of the present invention is described hereinafter.

The optical receiving module 200 includes a light collecting means formed on the front surface, an integrated module package 115′ with a pin structure in which plural protruding pins are parallel to the bottom s of the package 115′, a substrate 107 attached to the bottom surface of a cavity of the package 115′, and a light receiving element 108 attached to the front surface of the substrate 107.

The light collecting means includes a lens insertion hole 123 and a receiving lens 117 formed on the front surface of the package 115, and a receiving guide pipe 119 connected to the lens insertion hole 123 and provided with a hollow 119a in which a receiving ferrule 114 is inserted.

Similarly to the aforementioned optical transmitting module, the position of the light collecting means is not limited to the front surface of the package.

The receiving lens 117 usually employs a ball lens and is installed on a pre-calculated area within the lens insertion hole 123 so that the light from the optical fiber 113 is concentrated on a receiving area of the light receiving element 108.

The receiving guide pipe 119 includes the hollow 119a, in which the receiving ferrule 114 provided with the optical fiber 113 is inserted. The shape of the transmitting ferrule 112 is not limited. Preferably, the receiving ferrule 114 is cylindrical in shape. In this case, by allowing the internal diameter 119b of the hollow 119a to be substantially as much as the external diameter of the receiving ferrule 114, even though the cylinder-shaped receiving ferrule 114 is inserted in any direction into the hollow 119a, the light is exactly concentrated on the core of the optical fiber 113.

A protrusion 121 with a designated shape for fixing the substrate 107 is formed on the bottom surface of the cavity of the package 115′, and an opening for introducing the substrate 107 and a cover 126′ are formed on the upper su of the package 115′ . Herein, the position of the opening is also not limited thereto but changeable by the position of the light collecting means.

The protrusion 121 formed on the bottom surface of the cavity of the package 115′ serves to fix the substrate 107, the height of which is adjusted so that the light projected from the fiber 113 on the receiving lens 117 is concentrated on the receiving area of the light receiving element 108. The shape of the protrusion 121 is not limited. Therefore, the shape of the protrusion 121 may include a V-groove or a MESA structure with an inclined sidewall at a designated angle.

A designed pin structure 124′ for electrically connecting the light receiving element 108 to an external circuit board (not shown) is formed on one surface of the package 115′. The pins 124′ of this structure are usually a form of leads of the lead frame and parallel to the bottom surface of the package 115′. This pin structure 124′ is the same as the pin structure 124 of the first embodiment of the present invention, thus its detailed description is omitted.

Preferably, in order to reduce the overall size of the package 115′, the number of the pins 124′ is minimize. This embodiment of the present invention includes at least four pins, thereby reducing the size of the package. Further, the pins 124′ are protruded from the package 115′ parallel to the bottom suds of the package 115′, thereby easily mounting the package 115′ on the circuit board. By the aforementioned structure of the pins 124′, the optical transmitting module and the optical receiving module can be integrated as one optical module.

Preferably, the substrate 107 may be made of ceramic, but is not limited thereto. The receiving element 108 is attached to the front surface 107a of the substrate 107 by a solder 109 and electrically connected to the pins 124′ by a contact point 134.

A photo diode is generally used as the light receiving element 108. The light receiving element 108 is aligned and fixed on a designated area of the substrate 107 so as to be substantially opposite to the central axis of the receiving lens 117.

A depression 110 with a predetermined shape and size to be matched with the protrusion 121 formed on the bottom surface of the cavity of the package 115′ is formed on the bottom surface 107b of the substrate 107. The depression 110 may be formed by any conventional molding or cutting method.

The passive alignment between the package 115′ and the substrate 107 is simply achieved by matching the depression 110 of the substrate 107, with the protrusion 121 of the bottom surface of the package 115′. That is, since the final position of the light receiving element 108 is predetermined so that the light irradiated from the optical fiber 113 within the receiving ferrule 114 on the front surface of the substrate 107 is concentrated on the receiving area of the light receiving element 108, the passive alignment can be simply completed by only a subsequent step of inserting and fixing the receiving ferrule 14 in to the package 115′.

The optical receiving module of the present invention may be a multi-optical receiving module provided with at least two parallel-connected optical receiving modules.

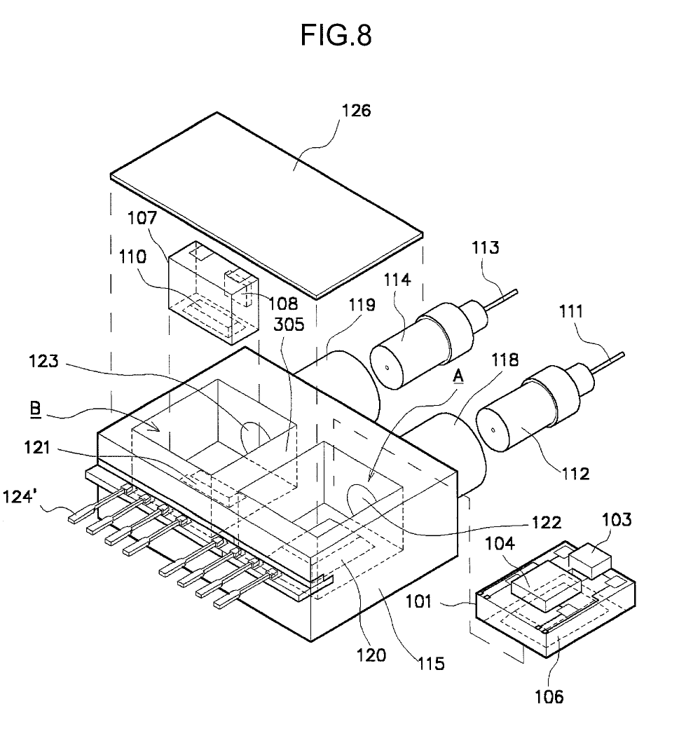

FIG. 8 is an exploded perspective view of an optical transceiver module in accordance with yet another embodiment of the present invention.

With reference to FIG. 8, the optical transceiver module 300 in accordance with yet another embodiment of the present invention is described hereafter.

The optical transceiver module 300 is formed by integrating the optical transmitting module 100 and the optical receiving module 200.

As shown in FIG. 8, a package of the optical transceiver module 300 includes the transmitting and receiving guide pipes 118, 119 connected to the lens insertion holes 122, 123 and formed on the front surface of the package, and the protrusions 120, 121 with a designated shape formed on the bottom surface of cavities A, B, which are separated by a diaphragm 305. The depressions 106, 110 with a predetermined shape and size to be matched with the protrusions 120, 121 are formed on the bottom surface of the transmitting and receiving substrate. Thereby, the bottom surface of the substrate is exactly aligned on the cavities of the package by the matching of the depressions 106, 110 of the substrate with the protrusions 120, 121 of the packages, respectively.

The openings for introducing the substrates 101, 107 and the cover 126 are formed on the upper surface of the packages.

The aforementioned transceiver module 300 is electrically connected to the transceiver electronic circuit board (not shown) for operating and controlling the active elements, which are installed on the transmitting module 100 and the receiving module 200.

The optical transceiver module of the present invention may be also a multi-optical transceiver module provided with at least two parallel-connected optical transceiver modules.

Hereinafter, a method of manufacturing the optical transceiver module of the present invention is described. However, an electrical connection step such as a wire bonding is apparent to those skilled in the art, thus its detailed description is omitted.

The integrated module package 115 is mounted on a stage (not shown). The silicon substrate 101 with the laser diode 103 and the monitoring photo diode 104 attached thereto is picked up. The picked-up silicon substrate 101 is moved into one cavity. A of the package 115, and then is received on a precise area of the silicon substrate 101 by matching the rectangular shaped depression 106 with an inclined sidewall and an even bottom slice with the protrusion 120 with a shape corresponding to the depression 106. The upper surface of the protrusion 120 is coated with a solder with a designated melting point.

In the same manner, the ceramic block 107 with the photo diode 108 attached thereto is picked up. The picked-up ceramic block 107 is moved into the other cavity B of the package 115, and then is received on a precise area of the ceramic block 107 by matching the rectangular-shaped depression 110 with an inclined sidewall and an even bottom surface with the protrusion 121 with a shape corresponding to the depression 110. The upper surface of the protrusion 121 is also coated with a solder with a designated melting point.

The stage is heated and the solders (not shown) coated on the protrusions 120, 121 are melted Thereby, the transmitting silicon substrate 101 and the receiving ceramic block 107 are attached to the precise areas of the integrated module package 115.

After attaching the transmitting silicon substrate 101 and the receiving ceramic block 107 to the integrated module package 115, the cover 126 is fixed to the upper surface of the integrated module package 115 by an electric welding under nitrogen atmosphere.

Then, each of the transmitting ferrule 112 including the transmitting optical fiber 111 and the receiving ferrule 114 including the receiving optical fiber 113 is inserted into the hollows 118a, 119a of the transmitting guide pipe 118 and the receiving guide pipe 119. Then a the transmitting ferrule 112 and the receiving ferrule 114 are fixed to the transmitting guide pipe 118 and the receiving guide pipe 119 by a laser welding. Thereby, the optical transmitting module 300 is manufactured.

In accordance with the preferred embodiments of the present invention, the package is easily mounted on a circuit board by protruding the outer pins of the package parallel to the bottom surface of the package. Further, an overall size of the package is reduced by properly adjusting the number of the pins. Thereby, the optical transmitting module and the optical receiving module may be integrated as one optical module.

Moreover, the present invention is easily capable of fulfilling the passive alignment between the package and the substrate without operating the luminous element or the light receiving element. That is, the optical module of the present invention is manufactured after the passive alignment of the package and the substrate, thereby simplifying the manufacturing process and shortening the alignment time.

Although the preferred embodiments of the present invention have been disclosed for illustrative purposes, those tilled in the art will appreciate that various modifications, additions and substitutions are possible, without departing from the scope and spirit of the invention as disclosed in the accompanying claims.

What is claimed is:

1. An optical transmitting module comprising:
a substrate with active elements, including a luminous element, attached thereto; and
a package comprising a light collecting means for transmitting light generated from the luminous element to an optical fiber and pins for electrically connecting said package to an external device,
wherein one end of said pin is electrically connected to said active elements and the other end of said pin is protruded from said package parallel to a bottom surface of the package.

2. The optical transmitting module as set forth in claim 1, wherein said pins include at least 4 pins spaced by a designated interval.

3. The optical transmitting module as set forth in claim 1, wherein a protrusion with a designated shape is formed on one of a bottom surface of said substrate and an upper surface of a bottom wall of a cavity of said package, and a depression to be matched with said protrusion is formed on the other, whereby a passive alignment between said package and said substrate is achieved by matching the protrusion with the depression.

4. The optical transmitting module as set forth in claim 3, wherein a protrusion of a MESA structure with an inclined sidewall at a designated angle is formed on the upper surface of the bottom wall of the cavity of said package.

5. The optical transmitting module as set forth in claim 3, wherein said package is made of a material selected from the group consisting of ceramic, metal, and equivalents thereof.

6. The optical transmitting module as set forth in claim 3, wherein said light collecting means comprises a guide pipe and a ferrule inserted into the guide pipe, and said ferrule is, when inserted, tightly coupled with said guide pipe by allowing an internal diameter of the guide pipe to be substantially as much as an external diameter of the ferrule.

7. An optical receiving module comprising:
a substrate with a light receiving element attached thereto; and
a package comprising a light collecting means for transmitting light to said light receiving element and pins for electrically connecting said package to an external device,
wherein one end of said pin is electrically connected to said light receiving element and the other end of said pin is protruded from said package parallel to a bottom surface of the package.

8. The optical receiving module as set forth in claim 7, wherein said pins include at least 4 pins spaced by a designated interval.

9. The optical receiving module as set forth in claim 7, wherein a protrusion with a designated shape is formed on one of a bottom surface of said substrate and an upper surface of a bottom wall of a cavity of said package, and a depression to be matched with said protrusion is formed on the other, whereby a passive alignment between said package and said substrate is achieved by matching the protrusion with the depression.

10. The optical receiving module as set forth in claim 9, wherein a protrusion of a MESA structure with an inclined sidewall at a designated angle is formed on the upper surface of the bottom wall of the cavity of said package.

11. The optical receiving module as set forth in claim 9, wherein said package is made of a material selected from the group consisting of ceramic, metal, and equivalents thereof.

12. The optical receiving module as set forth in claim 9, wherein said light collecting means comprises a guide pipe and a ferrule inserted into the guide pipe, and said ferrule is, when inserted, tightly coupled with said guide pipe by allowing an internal diameter of the guide pipe to be substantially as much as an external diameter of the ferrule.

13. An optical transceiver module formed by integrating the optical transmitting module as claimed in claim 1 and the optical receiving module as claimed in claim 7.

14. A multi-optical transmitting module comprising at least two optical transmitting modules as claimed in claim 1.

15. A multi-optical receiving module comprising at least two optical receiving modules as claimed in claim 7.

16. A multi-optical transceiver module comprising at least two optical transceiver modules as claimed in claim 13.
